(19) United States
(12) Patent Application Publication
(10) Pub. No.: US 2008/0239917 A1
(43) Pub. Date: Oct. 2, 2008

(54) AUDIO DATA OUTPUT APPARATUS AND AUDIO DATA OUTPUT METHOD

(75) Inventor: Takanobu MUKAIDE, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/045,506

(22) Filed: Mar. 10, 2008

(30) Foreign Application Priority Data
Mar. 29, 2007 (JP) 2007-086125

(51) Int. Cl. G11B 20/10

(52) U.S. Cl. 369/59.26

(57) ABSTRACT

According to one embodiment, a preset amount of padding data is added while a block number corresponding to a detecting period of sync information which becomes shorter is used as a packing unit when the detecting period of the sync information becomes shorter than an original period, and a block number corresponding to a detecting period of the sync information which becomes longer is divided while an original number of blocks contained in one packing unit is set as an upper limit and a preset amount of padding data is added with each divided block number used as a packing unit when the detecting period of the sync information becomes longer than the original period.

### CROSS-REFERENCE TO RELATED APPLICATIONS

This application is based upon and claims the benefit of priority from Japanese Patent Application No. 2007-086125, filed Mar. 29, 2007, the entire contents of which are incorporated herein by reference.

### BACKGROUND

1. Field

One embodiment of the invention relates to the improvement of a audio data output apparatus and audio data output method which output compression-coded audio data packed for every plural number of management blocks.

2. Description of the Related Art

As is well known in the art, recently, optical disks such as DVDs (digital versatile disks) or the like are popularly used as digital recording media. At present, next-generation DVDs which are called HD (high definition)-DVDs and can record with higher recording density than DVDs to cope with High-Vision are completed.

In this type of optical disk, data items such as video images and voices are subjected to a compression-coding process and recorded. Therefore, in a optical disk playback apparatus for playing an optical disk, compression-coded data is subjected to a decoding (expansion) process, converted into an analog form and output so that video images can be displayed and voices can be played back by use of an external monitor and speaker.

In the optical disk playback apparatus, audio data obtained before decoding, that is, maintained in a compression-coded form can be output to the exterior. Thus, voices of high sound quality with a multi-channel can be played back by use of an AV amplifier or the like which has a function of subjecting the compression-coded audio data to the decoding process and is externally attached to the optical disk playback apparatus.

The compression-coded audio data before decoding is packed for every plural number of management blocks and contains Sync (synchronization) information for each packing unit. In the optical disk playback apparatus, compression-coded audio data of one unit is detected based on Sync information, subjected to a preset data process to be output in a digital form and then output.

Therefore, for example, in a case where Sync information cannot be periodically acquired when an error or the like in reading data from an optical disk occurs, the data process for outputting the compression-coded audio data in the digital form cannot be correctly performed and the compression-coded audio data cannot be stably output to the exterior.

In Jpn. Pat. Appln. KOKAI Publication No. 2002-353928, the configuration is disclosed in which when non-stored coded data which is not yet stored in a transmission buffer does not have specified data size at the completion time of formation of one-frame coded data, part of a coded word configuring next coded data is sent in advance and attached to the non-stored coded data so as to cause the non-stored coded data to have the specified data size.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block configuration diagram schematically showing a disk playback apparatus according to one embodiment of this invention;

FIGS. 2A to 2C are diagrams for illustrating a data converting operation in a audio data converting portion of the disk playback apparatus of the present embodiment;

FIG. 3 is a flowchart for illustrating part of a processing operation in the audio data converting portion of the present embodiment;

FIG. 4 is a flowchart for illustrating the remaining part of the processing operation in the audio data converting portion of the present embodiment;

FIGS. 5A to 5C are diagrams for illustrating another example of the data converting operation in the audio data converting portion of the present embodiment;

FIG. 6 is a diagram for illustrating still another example of the data converting operation in the audio data converting portion of the present embodiment;

FIG. 7 is a flowchart for illustrating part of another example of the processing operation in the audio data converting portion of the present embodiment;

FIG. 8 is a flowchart for illustrating the remaining part of the other example of the processing operation in the audio data converting portion of the present embodiment;

FIG. 9 is a diagram for illustrating still another example of the data converting operation in the audio data converting portion of the present embodiment;

FIG. 10 is a block configuration diagram for illustrating an AV amplifier connected to the disk playback apparatus of the present embodiment;

FIG. 11 is a diagram for illustrating an extracting operation of a compressed data extracting portion of the AV amplifier in the present embodiment; and

FIG. 12 is a flowchart for illustrating the voice playback processing operation of the AV amplifier in the present embodiment.

### DETAILED DESCRIPTION

Various embodiments according to the invention will be described hereinafter with reference to the accompanying drawings. In general, according to one embodiment of the invention, a preset amount of padding data is added while a block number corresponding to a detecting period of sync information which becomes shorter is used as a packing unit when the detecting period of the sync information becomes shorter than an original period, and a block number corresponding to a detecting period of the sync information which becomes longer is divided while an original number of blocks contained in one packing unit is set as an upper limit and a preset amount of padding data is added with each divided block number used as a packing unit when the detecting period of the sync information becomes longer than the original period.

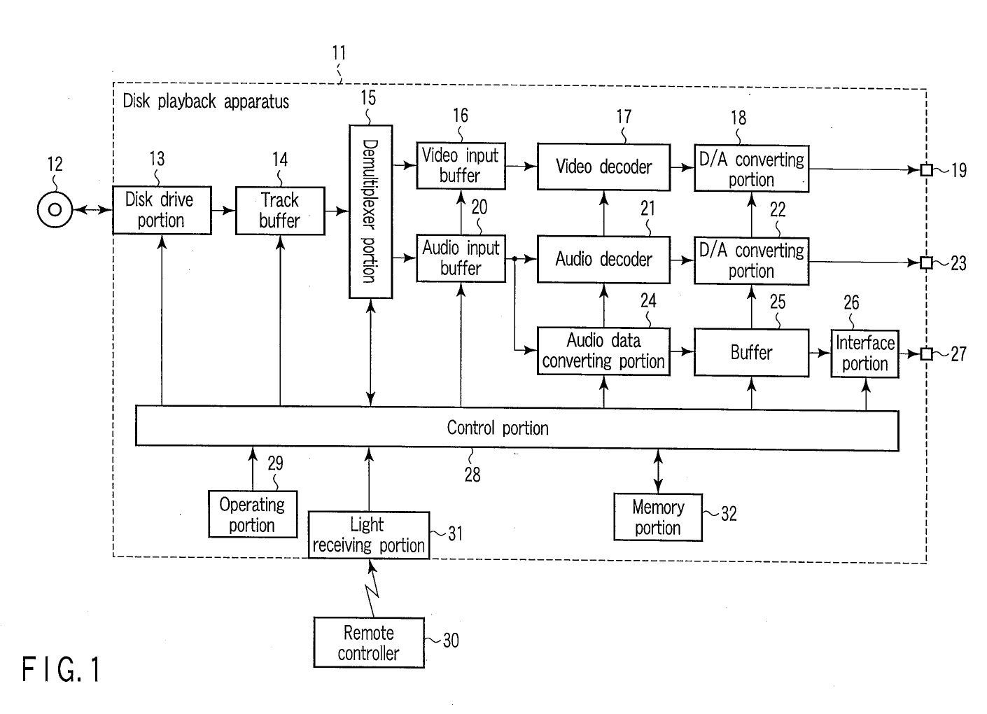

FIG. 1 schematically shows a disk playback apparatus 11 to be explained in this embodiment. The disk playback apparatus 11 includes a disk drive portion 13 on which an optical disk 12 such as a DVD (which contains an HD-DVD) is mounted and which reads out recording data thereof.

Data read out from the optical disk 12 by the disk drive portion 13 is temporarily stored in a track buffer 14 and then supplied to a demultiplexer portion 15. The demultiplexer portion 15 divides input data into video data and audio data subjected to a compression-coding process.

Video data among the above data items is supplied to a video decoder 17 via a video input buffer 16 and subjected to a decoding process. Then, the decoded video data is supplied to a D/A (digital/analog) converting portion 18, converted into analog video data, output to the exterior via a video output terminal 19 and then displayed on a monitor (not shown), for example.

Further, audio data divided in the demultiplexer portion 15 is supplied to a audio decoder 21 via a audio input buffer 20 and subjected to a decoding process. Then, the decoded audio data is supplied to a D/A converting portion 22, converted into analog audio data, output to the exterior via a audio output terminal 23 and then played back by use of a speaker (not shown), for example.

Further, audio data stored in the audio input buffer 20 is supplied to a audio data converting portion 24. The audio data converting portion 24 performs a preset data converting process to output the input audio data in the digital form by use of a buffer 25 as will be described later in detail.

The converted audio data is converted into a transmission form in conformity to the HDMI (high definition multimedia interface) standard, for example, by the interface portion 26 and then output to the exterior via a digital audio output terminal 27. An AV amplifier or the like having a function of subjecting compression-coded audio data to the decoding process, for example, is connected to the digital audio output terminal 27, and therefore, high-quality voices with a multi-channel can be played back.

Then, all of the operations of the disk playback apparatus 11 containing the above playback operation are generally controlled by a control portion 28. The control portion 28 contains a CPU (central processing unit) and the like, receives operation information from the operating portion 29 or operation information output from a remote controller 30 and received by a light receiving portion 31 and controls the respective portions to reflect the received operation contents.

In this case, the control portion 28 utilizes a memory portion 32. As the memory portion 32, a ROM (read only memory) in which control programs executed by the CPU of the control portion 28 are stored, a RAM (random access memory) which provides a working area for the CPU and a nonvolatile memory for storing various set information items and control information items are mainly used.

Now, the audio data converting process in the audio data converting portion 24 is explained. Compression-coded audio data is managed in a block unit and packed with N (integral number equal to or larger than 2) blocks used as one unit. The first one of the blocks configuring one packing unit contains Sync information.

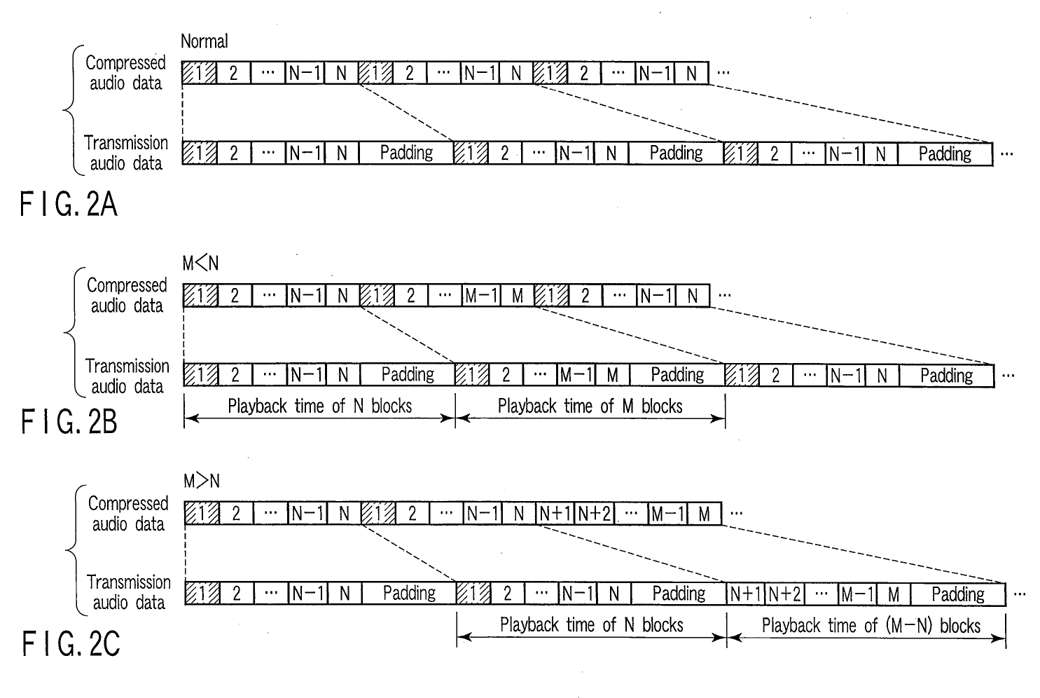

In the audio data converting portion 24, as shown by compressed audio data of FIG. 2A, audio data is acquired in the packing unit from the audio input buffer 20. In this case, the audio data converting portion 24 reads out audio data of one block from the audio input buffer 20 and determines whether or not Sync information is contained in the audio data. If Sync information is contained, audio data items are serially acquired in the block unit until a block with Sync information is next read out. In FIGS. 2A to 2C, blocks containing Sync information are indicated by hatched portions.

In the audio data converting portion 24, as shown by transmission audio data of FIG. 2A, a converting process is performed to insert a preset amount of padding data (normally, “0” data) into compressed audio data of N blocks read out in the packing unit from the audio input buffer 20 and then the thus obtained data is output in a digital form to the exterior.

As padding data, a data amount obtained by subtracting a compressed audio data amount of N blocks from a transmission data amount corresponding to playback time required for subjecting compressed audio data of N blocks to the decoding process is inserted into the compressed audio data of N blocks while the block containing the Sync information is set in the first place. Thus, the voice playback operation can be smoothly performed without skipping by use of an external AV amplifier by inserting the padding data into the compressed audio data of N blocks and outputting the thus obtained data in a digital form.

FIG. 2A shows a normal state where Sync information periodically appears for every N blocks in audio data read out from the audio input buffer 20. In such a normal state, the audio data converting portion 24 can add padding data to audio data for every N blocks containing Sync information in the head block which and output the thus obtained data to the exterior in the digital form.

However, for example, the block with Sync information does not periodically appear for every N blocks in some cases due to an error in reading from the optical disk 12. In this case, the block with Sync information appears at an interval shorter or longer than the length of N blocks. Therefore, if padding data of an amount obtained by subtracting a compressed audio data amount of N blocks from a transmission data amount corresponding to the playback time required for subjecting the compressed audio data of N blocks to the decoding process is inserted into the compressed audio data of N blocks and the thus obtained data is output, a difference occurs between the playback time of the audio data output in the digital form and the playback time of compressed audio data stored in the audio input buffer 20 and underflow or overflow occurs in the audio input buffer 20.

Therefore, in the present embodiment, as shown by compressed audio data of FIG. 2B, when a block with Sync information appears at an interval M shorter than the length of N blocks from the audio input buffer 20, padding data of an amount obtained by subtracting a compressed audio data amount of M blocks from a transmission data amount corresponding to the playback time required for decoding the compressed audio data of N blocks is inserted into the compressed audio data of M blocks as shown by transmission audio data of FIG. 2B and the thus obtained data is output in a digital form.

Further, as shown by compressed audio data of FIG. 2C, when a block with Sync information appears at an interval M longer than the length of N blocks from the audio input buffer 20, padding data of a necessary amount is inserted for every N blocks even if the Sync information is not present as shown by transmission audio data of FIG. 2C and the thus obtained data is output in a digital form. In this case, padding data is inserted with the N blocks set as an upper limit.

For example, in the case of N=6 and M=13, that is, when Sync information appears at an interval of 13 blocks, compressed audio data of 13 blocks is divided into 6 blocks+6 blocks+1 block. Then, for the first two groups of 6 blocks, padding data is inserted so as to complete transmission of data in the playback time of compressed audio data of 6 blocks. For the last one block, padding data is inserted so as to complete transmission of data in the playback time of compressed audio data of one block.

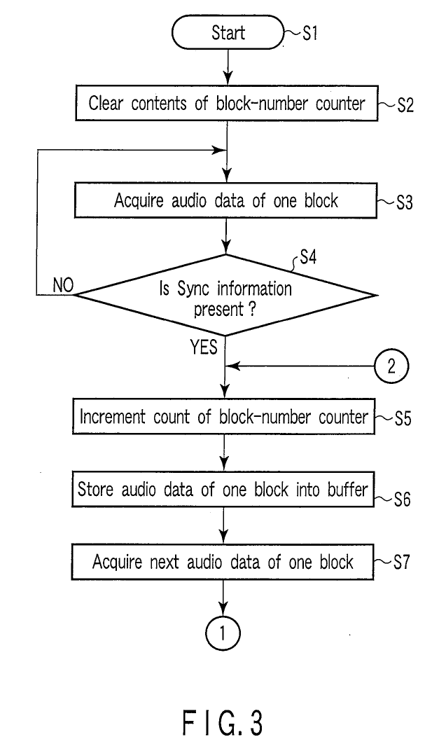

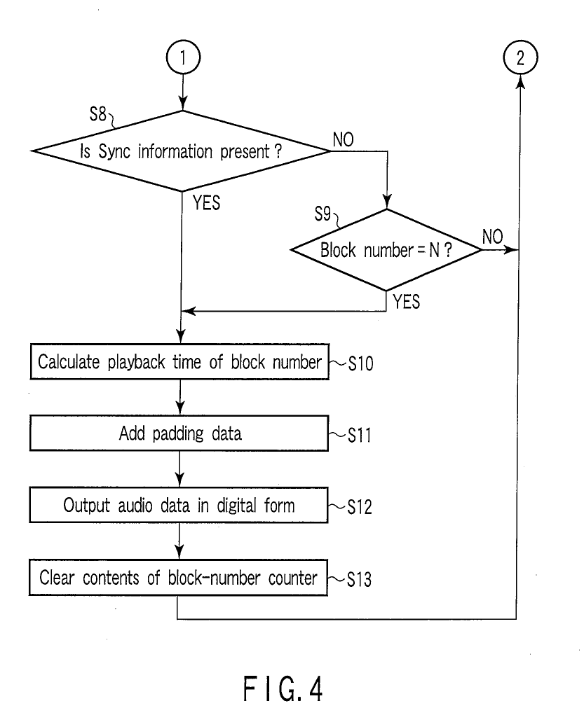

FIGS. 3 and 4 are flowcharts for illustrating a processing operation in the audio data converting portion 24. That is, when the process is started (step S1), the audio data converting portion 24 clears the contents of a counter (not shown) for counting the block number in the step S2 and acquires audio data of one block from the audio input buffer 20 in the step S3.

After this, the audio data converting portion 24 determines whether or not Sync information is contained in one block previously acquired in the step S4. If it is determined that the Sync information is not contained (NO), the process is returned to the step S3 and next audio data of one block is acquired.

Further, if it is determined in the step S4 that the Sync information is contained (YES), the audio data converting portion 24 increments the count of the counter by “1” in the step S5, stores audio data of one block previously acquired into the buffer 25 in the step S6 and acquires next audio data of one block in the step S7.

After this, the audio data converting portion 24 determines in the step S8 whether or not Sync information is contained in one block previously acquired. If it is determined that the Sync information is not contained (NO), it determines in the step S9 whether or not the block number has reached N, and if it is determined that N is not reached (NO), the process is returned to the step S5.

If it is determined in the step S9 that the block number has reached N (YES) or if it is determined in the step S8 that the Sync information is contained (YES), the audio data converting portion 24 calculates playback time of a counted block number in the step S10 and determines an amount of padding data to be added based on the playback time previously calculated and adds padding data to audio data in the buffer 25 in the step S11.

After this, the audio data converting portion 24 transfers audio data with padding data in the buffer 25 to the interface portion 26 and outputs the same in a digital form in the step S12. Then, it clears the contents of the block-number counter in the step S13 and the process is returned to the step S5.

In the present embodiment, when Sync information is acquired at an interval M shorter than the length of N blocks, padding data used for acquiring the playback time of M blocks is added to compressed audio data of M blocks. Further, when Sync information is acquired at an interval M longer than the length of N blocks, padding data used for acquiring the playback time of M blocks is added for every N blocks even if Sync information is not present. Therefore, it becomes possible to prevent occurrence of underflow or overflow in the audio input buffer 20 and stably output data in the digital form.

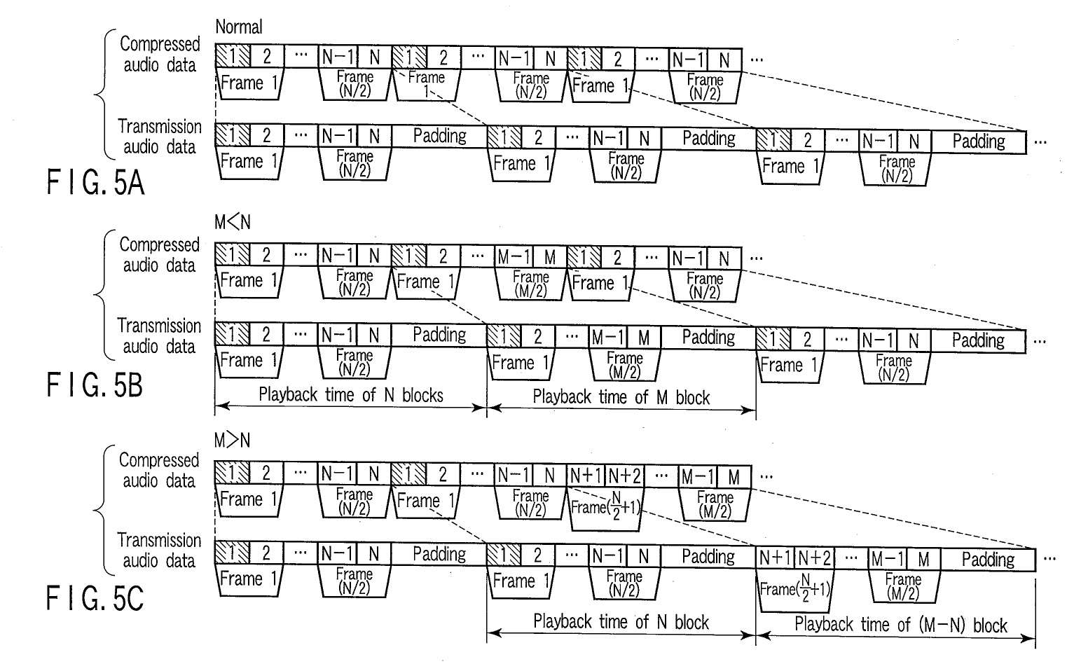

Further, in the present embodiment, an example in which the compressed audio data is managed in the block unit is explained. Next, a case of the data configuration in which a plurality of blocks are present in one frame which is the decoding unit of compressed audio data is explained. FIGS. 5A to 5C respectively correspond to FIGS. 2A to 2C and show a case where compressed audio data of two blocks is present in one frame.

With the above data configuration, compressed audio data is processed in the frame unit. That is, the process of acquiring compressed audio data by the audio data converting portion 24 is performed for each frame and the number of blocks present in the frame is checked after data acquisition.

When the block number is counted and Sync information periodically appears for every N blocks as shown in FIG. 5A, padding data used for acquiring the playback time of N blocks is added to the compressed audio data of N blocks acquired in the frame unit and thus transmission audio data is generated.

Further, as shown in FIG. 5B, when Sync information appears at an interval M shorter than the length of N blocks, padding data used for acquiring the playback time of M blocks is added to the compressed audio data of M blocks acquired in the frame unit and thus transmission audio data is generated.

Also, as shown in FIG. 5C, when Sync information is acquired at an interval M longer than the length of N blocks, the compressed audio data of M blocks acquired in the frame unit is divided in the frame unit with the N blocks set as an upper limit, padding data used for acquiring the playback time of the block number is added to each divided compressed audio data and thus transmission audio data is generated.

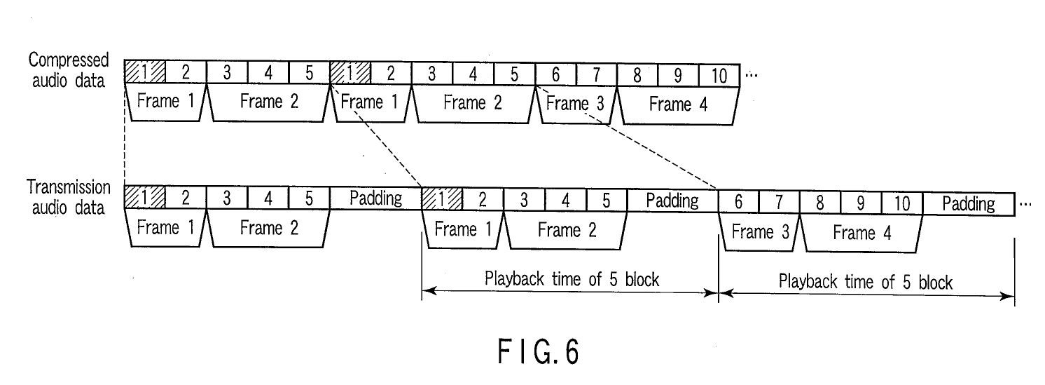

In FIGS. 5A to 5C, an example in which compressed audio data of two blocks is present in one frame is explained, but the number of blocks present in one frame can be set to any value. For example, as shown by compressed audio data of FIG. 6, a case wherein a frame in which two blocks are present and a frame in which three blocks are present are provided together is considered.

In such a case, as described above, when padding data is added with N=6 blocks set as an upper limit, transmission compressed data having padding data added thereto with 6 blocks used as one unit cannot be generated. At this time, as shown by transmission audio data of FIG. 6, data is divided in the unit of five blocks having a combination of a frame of two blocks and a frame of three blocks and padding data is added to each divided data.

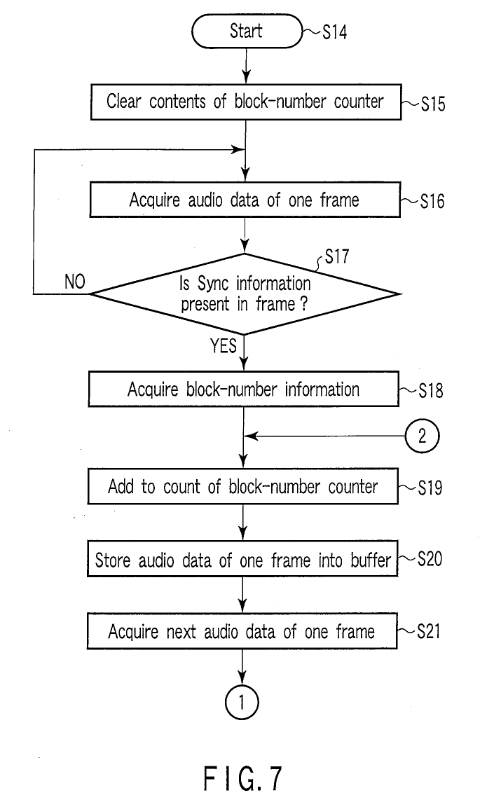

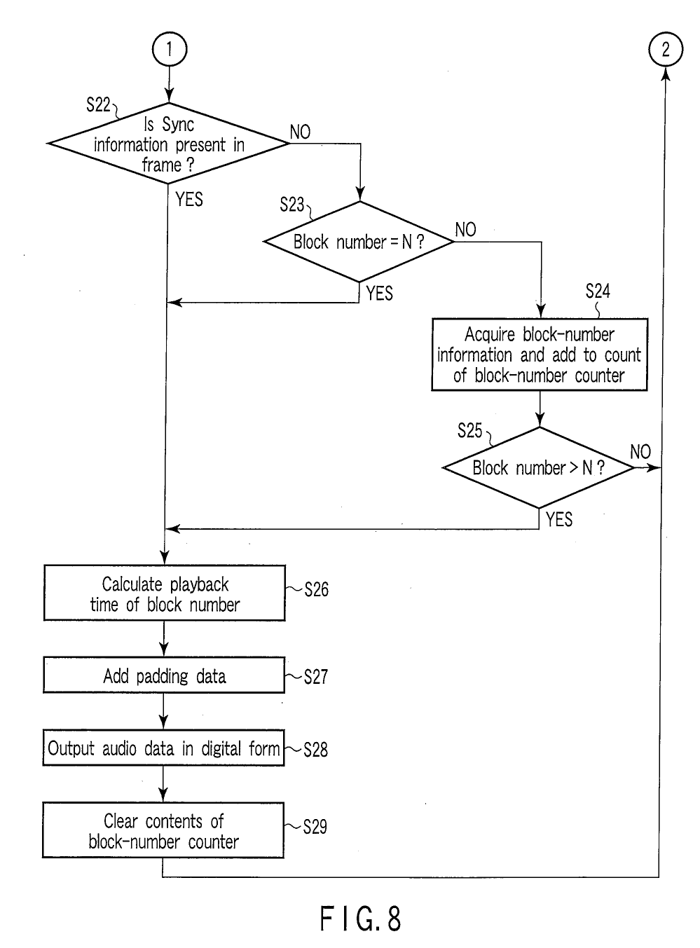

FIGS. 7 and 8 are flowcharts showing the processing operation of the audio data converting portion 24 when a plurality of blocks are present in one frame. That is, when the process starts (step S14), the audio data converting portion 24 clears the contents of a counter (not shown) which counts the block number in the step S15 and acquires audio data of one frame from the audio input buffer 20 in the step S16.

Then, the audio data converting portion 24 determines whether or not Sync information is present in one frame previously acquired in the step S17. If it is determined that the Sync information is not present (NO), the process is returned to the step S16 and it acquires next audio data of one frame.

Further, if it is determined in the step S17 that the Sync information is present (YES), the audio data converting portion 24 acquires information indicating the number of blocks present in the frame in the step S18 and adds the acquired block number to the count of the counter in the step S19.

After this, the audio data converting portion 24 stores audio data of one frame previously acquired into the buffer 25 in the step S20 and acquires next audio data of one frame in the step S21.

Then, the audio data converting portion 24 determines whether or not Sync information is contained in one frame previously acquired in the step S22. If it is determined that the Sync information is not contained (NO), it determines whether or not the block number has reached N in the step S23.

If it is determined that the block number has not reached N (NO), the audio data converting portion 24 acquires information indicating the number of blocks present in the frame in the step S24 and adds the acquired block number to the count of the counter.

Next, the audio data converting portion 24 determines whether or not the block number counted by the block-number counter becomes larger than N in the step S25. If it is determined that the block number is not larger than N (NO), the process is returned to the step S19.

If it is determined in the step S25 that the block number is larger than N (YES), if it is determined in the step S22 that the Sync information is contained (YES) or if it is determined in the step S23 that the block number has reached N (YES), then the audio data converting portion 24 calculates the playback time of the counted block number in the step S26, determines an amount of padding data to be added based on the playback time previously calculated in the step S27 and adds padding data to audio data in the buffer 25.

After this, the audio data converting portion 24 transfers audio data with the padding data in the buffer 25 to the interface portion 26, outputs data in a digital form in the step S28 and clears the contents of the block-number counter in the step S29 and the process is returned to the step S19.

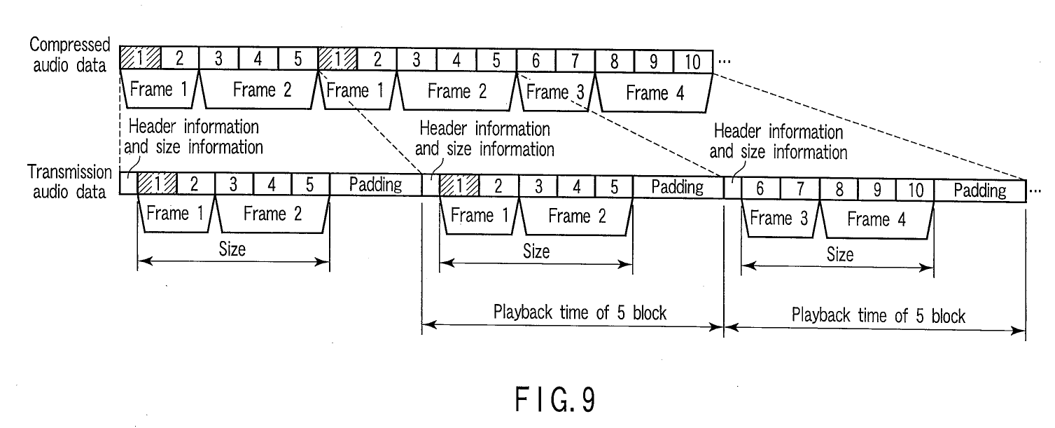

Further, as shown by transmission audio data of FIG. 9, header information and size information indicating the size (five blocks) of compressed audio data may be added to the head portion of compressed audio data of five blocks divided in the frame unit with N=6 blocks set as an upper limit.

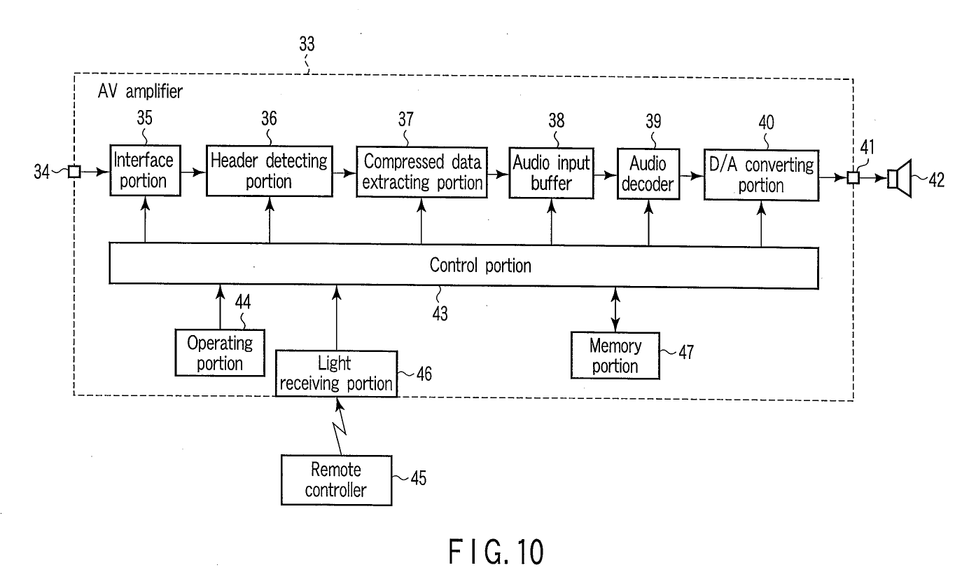

FIG. 10 shows one example of an AV amplifier 33 to which transmission audio data having header information and size information added thereto as shown in FIG. 9 is input. That is, the AV amplifier 33 has a digital audio input terminal 34 to which transmission audio data output in an output state in conformity to the HDMI standard from the digital audio output terminal 27 of the disk playback apparatus 11 is input.

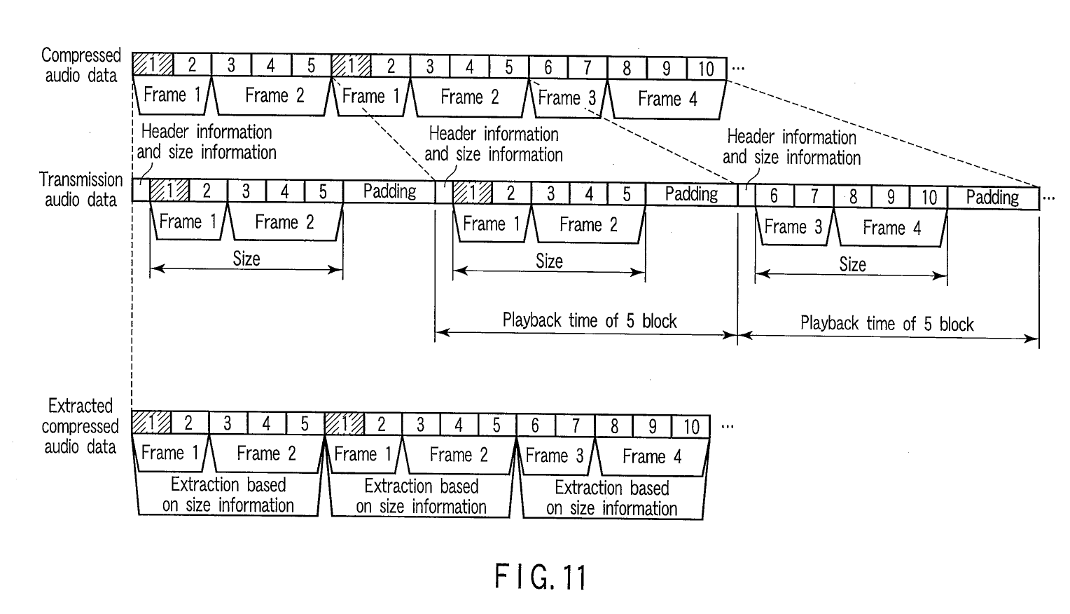

The transmission audio data input to the digital audio input terminal 34 is received by an interface portion 35 which conforms to the HDMI standard, supplied to a header detecting portion 36 in which header information and size information are detected, and then supplied to a compressed data extracting portion 37. The compressed data extracting portion 37 extracts compressed audio data from which header information, size information, padding data and the like are eliminated from the input data as shown in FIG. 11 based on the previously detected header information and size information.

The compressed audio data extracted by the compressed data extracting portion 37 is temporarily stored in a audio input buffer 38, then supplied to a audio decoder 39 and subjected to a decoding process. After this, the audio data subjected to the decoding process by the audio decoder 39 is supplied to a D/A converting portion 40, converted into an analog form, supplied to an external speaker 42 via a audio output terminal 41 and used for voice playback.

All of the operations of the AV amplifier 33 including the above voice playback operation are generally controlled by a control portion 43. The control portion 43 contains a CPU and the like and receives operation information from an operating portion 44 or operation information transmitted from a remote controller 45 and received by a light receiving portion 46 to control the respective portions and reflect the received information contents.

In this case, the control portion 43 utilizes a memory portion 47. As the memory portion 47, a ROM in which control programs executed by the CPU of the control portion 43 are stored, a RAM which provides a working area for the CPU and a nonvolatile memory for storing various set information items and control information items are mainly used.

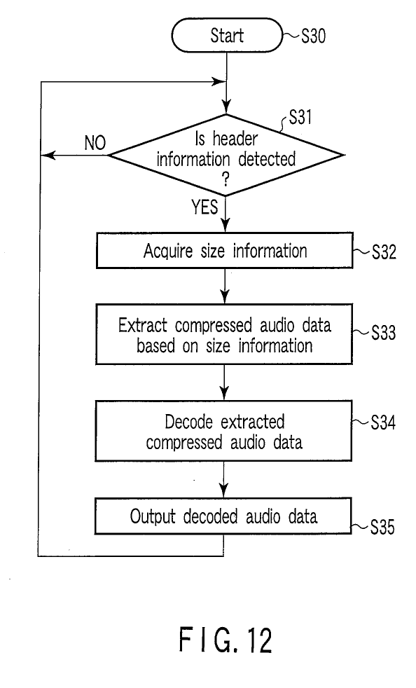

FIG. 12 is a flowchart for illustrating the voice playback processing operation of the AV amplifier 33. That is, when the process is started (step S30), the control portion 43 determines whether or not header information is detected by the header detecting portion 36 in the step S31. If it is determined that header information is detected (YES), it acquires size information provided together with the detected header information in the step S32.

After this, the control portion 43 causes the compressed data extracting portion 37 to extract compressed audio data based on the size information in the step S33, causes the audio decoder 39 to subject the extracted compressed audio data to a decoding process in the step S34 and outputs the decoded audio data to the exterior in the step S35 and then the process is returned to the step S31.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A audio data output apparatus comprising:
a storage portion which packs compressed audio data managed in a block unit by use of a preset number of blocks containing a block having sync information added thereto and stores the same,
a converting portion which reads out the compressed audio data stored in the storage portion in a packing unit by detecting the sync information and adds a preset amount of padding data thereto, adds a preset amount of padding data while a block number corresponding to a detecting period of the sync information which becomes shorter is used as a packing unit when the detecting period of the sync information becomes shorter than an original period obtained by use of the number of blocks configuring one packing unit, and divides a block number corresponding to a detecting period of the sync information which becomes longer while an original number of blocks contained in one packing unit is set as an upper limit and adds a preset amount of padding data with each divided block number used as a packing unit when the detecting period of the sync information becomes longer than the original period obtained by use of the number of blocks configuring one packing unit, and
an output portion which outputs compressed audio data of the packing unit having the padding data added thereto and obtained by the converting portion to an exterior.

2. A audio data output apparatus comprising:
a storage portion which packs compressed audio data managed in a block unit by use of a preset number of blocks containing a block having sync information added thereto and stores the same,
a converting portion which reads out the compressed audio data stored in the storage portion in a packing unit by detecting the sync information and adds a preset amount of padding data thereto, adds a preset amount of padding data while a block number corresponding to a detecting period of the sync information which becomes shorter is used as a packing unit when the detecting period of the sync information becomes shorter than an original period obtained by use of the number of blocks configuring one packing unit, and
an output portion which outputs compressed audio data of the packing unit having the padding data added thereto and obtained by the converting portion to an exterior.

3. A audio data output apparatus comprising:
a storage portion which packs compressed audio data managed in a block unit by use of a preset number of blocks containing a block having sync information added thereto and stores the same,
a converting portion which reads out the compressed audio data stored in the storage portion in a packing unit by detecting the sync information and adds a preset amount of padding data thereto, and divides a block number corresponding to a detecting period of the sync information which becomes longer while an original number of blocks contained in one packing unit is set as an upper limit and adds a preset amount of padding data with each divided block number used as a packing unit when the detecting period of the sync information becomes longer than the original period obtained by use of the number of blocks configuring one packing unit, and
an output portion which outputs compressed audio data of the packing unit having the padding data added thereto and obtained by the converting portion to an exterior.

4. A audio data output apparatus according to any one of claims 1, 2 and 3, wherein the converting portion is configured to add padding data of an amount obtained by subtracting a compressed audio data amount of an original block number contained in one packing unit from a transmission data amount corresponding to playback time required for subjecting compressed audio data of the original number of blocks contained in one packing unit containing a block having sync information added thereto to a decoding process.

5. A audio data output apparatus according to any one of claims 1, 2 and 3, wherein the converting portion is configured to divide the block number corresponding to the detecting period of the sync information in the frame unit while the original block number contained in one packing unit is set as an upper limit when the compressed audio data is configured to have a plurality of blocks contained in one frame which is a decoding unit.

6. A audio data output apparatus according to any one of claims 1, 2 and 3, wherein the converting portion is configured to add header information and size information of the compressed audio data to a head portion of the compressed audio data in the packing unit having padding data added thereto.

7. A audio data output method comprising:
a first step of packing compressed audio data managed in a block unit by use of a preset number of blocks containing a block having sync information added thereto and storing the same,
a second step of reading out the compressed audio data stored in the first step in a packing unit by detecting the sync information and adding a preset amount of padding data thereto,
a third step of adding a preset amount of padding data while a block number corresponding to a detecting period of the sync information which becomes shorter is used as a packing unit when the detecting period of the sync information in the compressed audio data stored in the first step becomes shorter than an original period obtained by use of the number of blocks configuring one packing unit,
a fourth step of dividing a block number corresponding to a detecting period of the sync information which becomes longer while an original number of blocks contained in one packing unit is set as an upper limit and adding a preset amount of padding data with each divided block number used as a packing unit when the detecting period of the sync information in the compressed audio data stored in the first step becomes longer than the original period obtained by use of the number of blocks configuring one packing unit, and
a fifth step of outputting compressed audio data of the packing unit having the padding data added thereto and obtained in one of the first to fourth steps.

8. A audio data reception apparatus comprising:
a receiving portion which receives data output from the audio data reception apparatus described in claim 6,
a detecting portion which detects header information from the data received by the receiving portion,
an extracting portion which acquires size information and extracts compressed audio data from the data received by the receiving portion when header information is detected by the detecting portion, and
a decoding portion which subjects the compressed audio data extracted by the extracting portion to a decoding process.
